(19) United States
(12) Patent Application Publication
(10) Pub. No.: US 2018/0300683 A1
(43) Pub. Date: Oct. 18, 2018

(54) Joint Delivery Planning Apparatus and Joint Delivery Planning Method

(71) Applicant: Hitachi, Ltd., Tokyo (JP)

(72) Inventor: Futoshi KOIKE, Tokyo (JP)

(21) Appl. No.: 15/947,534

(22) Filed: Apr. 6, 2018

(30) Foreign Application Priority Data
Apr. 12, 2017 (JP) 2017-079023

(51) Int. Cl. G06Q 10/08; G01C 21/34

(52) U.S. Cl. CPC G06Q 10/08355; G01C 21/3453; G06Q 10/0832

(57) ABSTRACT

A joint delivery planning apparatus includes: an information acquiring unit that acquires order information and consignor information on consignors; a constraint condition setting unit that sets a plurality of constraint conditions for each of the consignors by changing constraint conditions of each of the consignors; a delivery planning unit that generates a joint delivery plan for each of the constraint conditions of each of the consignors, using the order information, the consignor information, and the plurality of constraint conditions of each of the consignors; a contribution degree calculating unit that calculates a contribution degree of the consignor with respect to a total delivery cost indicated by the corresponding joint delivery plan for each of the constraint conditions; and an output processing unit that outputs the contribution degree for each of the constraint conditions of each of the consignors.

### CLAIM OF PRIORITY

This application claims the priority from the Japanese Patent Application No. 2017-079023 filed on Apr. 12, 2017, the content of which is incorporated herein by reference into this application.

### TECHNICAL FIELD

The present invention relates to a joint delivery planning apparatus and a joint delivery planning method.

### BACKGROUND ART

In recent years, personal computers (PCs) or smartphones come into wide use, and consumer's use of the Internet mail ordering is explodingly increasing. Additionally, Internet mail-order companies provide high value-added services such as immediate delivery and time-designated delivery to intensively meet consumer needs.

Meanwhile, deliverers have to deliver a wide variety of goods and a large amount of cargo at a finely designated time so as to provide the high value-added services to the consumer. However, response actions have not been made in time due to the lack of drivers in recent years, and this is becoming a social issue.

Joint delivery is known as a highly efficient delivery method to solve the above social issue. This is a method of mixed-loading and delivering cargo, which is delivered by each consignor using individual transport vehicles (for example, truck), using trucks shared by a plurality of consignors. By loading cargo in an empty cargo box in the individual delivery, it is possible to increase loading efficiency per one truck and reduce the number of trucks required for delivery. As a result, reduction of the number of drivers and reduction of delivery costs can be realized.

Techniques related to the joint delivery are disclosed in JP-A-2004-213466 (PTL 1) and JP-A-2006-185133 (PTL 2). A technique is disclosed in PTL 1 in which actual results of the cargo quantity and cargo delivery distance with respect to each consignor are totalized and a delivery fee for each consignor is calculated based on a ratio of the totalized actual results. A technique is disclosed in PTL 2 in which additional consignors publicly participate by releasing truck information having a sufficient margin space for loading on the Internet and profits due to the reduction in delivery cost according to the joint delivery is returned to the consignor according to the cargo quantity.

### CITATION LIST

### Patent Literature

PTL 1: JP-A-2004-213466

PTL 2: JP-A-2006-185133

### SUMMARY OF INVENTION

### Technical Problem

In the actual joint delivery plan, each consignor has not only the cargo quantity but also various constraint conditions (for example, a delivery order, an arrival time, and a rating of transport vehicle), and these constraint conditions need to be taken into account. In addition, constraint conditions of any consignor may affect delivery of another consignor. For example, when an arrival time is designated by any consignor, the delivery time to another consignor is quickened or delayed. Further, for example, the rating of a truck to be used is designated by any consignor, the cargo quantity of another consignor may be limited.

Therefore, merely determining allocation of the delivery cost based on the cargo quantity of each consignor cannot maintain fairness in the allocation of the delivery cost to consignors who suffer disadvantages due to the constraint conditions of another consignor. The inability to expect the fairness in the allocation of the delivery cost may be a factor that hampers the increase in consignors who use the joint delivery and delays the spread of the joint delivery. In the above PTL 1 and PTL 2, the fairness can hardly be maintained because the allocation of fare cost for the joint delivery or the allocation of reduction cost due to the joint delivery are calculated based on the cargo quantity of each consignor.

An object of the invention is to provide a joint delivery planning apparatus and a joint delivery planning method that support creation of a joint delivery plan in consideration of allocation of a delivery cost with more fairness.

### Solution to Problem

The present application includes a plurality of pieces of means for solving at least a part of the problems, and examples thereof are given as follows.

An aspect of an embodiment of the invention for solving the above problems is to provide a joint delivery planning apparatus that generates a joint delivery plan to jointly deliver cargoes of a plurality of consignors to each of the consignors, the apparatus including: an information acquiring unit that acquires order information of each of the consignors and consignor information on each of the consignors; a constraint condition setting unit that sets a plurality of constraint conditions for each of the consignors by changing constraint conditions of each of the consignors; a delivery planning unit that generates the joint deli plan for each of the constraint conditions of each of the consignors, using the order information, the consignor information, and the plurality of constraint conditions of each of the consignors; a contribution degree calculating unit that calculates a contribution degree of the consignor with respect to a total delivery cost indicated by the corresponding joint delivers/plan for each of the constraint conditions; a contribution degree information storing unit that stores the contribution degree for each of the constraint conditions of each of the consignors; and an output processing unit that outputs the contribution degree for each of the constraint conditions of each of the consignors with reference to the contribution degree information storing unit.

### Advantageous Effects of Invention

According to the invention, it is possible to support creation of a joint delivery plan in consideration of allocation of a delivery cost with higher fairness.

Other objects, configurations, and effects than those described above are made clear by a description of an embodiment given below.

### BRIEF DESCRIPTION OF DRAWINGS

FIG. 1 is a diagram illustrating a configuration example of a joint delivery planning apparatus according to an embodiment.

FIG. 2 is a diagram illustrating an example of a data structure of an order information storing unit according to the embodiment.

FIG. 3 is a diagram illustrating an example of a data structure of a consignor information storing unit according to the embodiment.

FIG. 4 is a diagram illustrating an example of a data structure of a contribution degree information storing unit according to the embodiment.

FIG. 5 is a diagram illustrating a configuration example of hardware of the joint delivery planning apparatus according to the embodiment.

FIG. 6 is a flowchart illustrating a processing example of the joint delivery planning apparatus according to the embodiment.

FIG. 7 is a flowchart illustrating an example of a process of calculating a contribution degree according to the embodiment.

FIG. 8 is a diagram illustrating calculation of a delivery cost in consideration of a contribution degree according to the embodiment.

FIG. 9 is a diagram illustrating an example of an output screen of the joint delivery planning apparatus according to the embodiment.

FIG. 10 is a diagram illustrating an example of a data structure of a contribution degree information storing unit according to a first modification.

FIG. 11 is a diagram illustrating an example of a screen according to the first modification.

FIG. 12 is a flowchart illustrating an example of a process of calculating a contribution degree according to a second modification.

FIG. 13 is a diagram illustrating an example of a screen according to the second modification.

FIG. 14 is a diagram illustrating a configuration example of a joint delivery planning apparatus according to a third modification.

FIG. 15 is a flowchart illustrating a processing example of the joint delivery planning apparatus according to the third modification.

### DESCRIPTION OF EMBODIMENTS

First, a description will be given in detail with respect to cost allocation in a joint delivery.

In general, the more consignors participating in joint delivery, the lower the overall delivery cost tends to be. In the operation of the joint delivery, however, since there are circumstances (constraint conditions) of individual consignors such as a delivery order, an arrival time, and a rank of transport vehicle, these constraint conditions need to be taken into consideration. In addition, some consignor s constraint conditions may affect other consignor's delivery.

As an example, a case is considered in which a consignor A and a consignor B deliver a cargo of 9 tons and a cargo of 1 ton, respectively, using a 5-ton truck with a charter fee of 10,000 yen. In this case, the delivery costs of the consignors will be 20,000 yen and 10,000 yen, respectively, and a total delivery cost will be 30,000 yen. A case is considered in which the cargoes of both consignors are delivered in a joint delivery manner. In this case, since the cargoes of both consignors can be delivered using two 5-ton trucks, the total delivery cost will be 20,000 yen.

Here, a burden cost (delivery cost) of each consignor is estimated for the total delivery cost of the joint delivery using the technique disclosed in PTL 1 described above. Then, the burden cost of the consignor A and the burden cost of the consignor B will be 18,000 yen and 2,000 yen, respectively, according to the cargo quantity. At this time, the respective consignors have delivery cost reduction rates of 10% and 80% compared with an individual delivery.

The joint delivery is influenced by constraint conditions of individual consignor such as a cargo delivery order, so the restrictions on the degree of freedom of each consignor's delivery planning are stronger than the case of the individual delivery. In view of this, it can be understood in the above example that fairness is not maintained for the consignor A who has a low delivery cost reduction rate in spite of the cargo quantity. Therefore, there is a task that the fairness in allocation of the delivery cost between the consignors should be maintained in the joint delivery.

In the above example, it is assumed that the truck rating is greatly changed. For example, a case is considered in which an individual delivery is performed using a 10-ton truck with a charter fee of 15,000 yen. In this case, the delivery costs of the consignors will be 15,000 yen, respectively, and a total delivery cost will be 30,000 yen. A case is considered in which the cargoes of both consignors are delivered in a joint delivery manner. In this case, since the cargoes of both consignors can be delivered using one 10-ton truck, the total delivery cost will be 15,000 yen. The total delivery cost can be reduced by 5,000 yen compared to the case of using two 5-ton trucks. When the burden costs (delivery cost) of the respective consignors are estimated using the technique disclosed in PTL 1 described above for the total delivery cost of the joint delivery, the burden cost of the consignor A and the burden cost of the consignor B will be 13,500 yen and 1,500 yen, respectively, according to the cargo quantity.

Here, assuming that a warehouse of the consignor B is small and can hardly deal with unloading of a 10-ton truck. In this case, it is inevitable to use the 5-ton truck according to the constraint condition of the consignor B in order to realize the joint delivery. Then, the consignor A can take the loss of 4,500 yen which is a difference between the burden cost of 18,000 yen at the time of using the 5-ton truck and the burden cost of 13,500 yen at the time of using the 10-ton truck.

In the above situation, the consignor A may select an individual delivery instead of the joint delivery, which may reduce the improvement effect of the joint delivery due to participation of a plurality of consignors. Therefore, in order to prevent decrease in the number of consignors who participate in the joint delivery, there is a task to incorporate a system that compensates such losses.

In the technique disclosed in PTL 2 described above, after the profit obtained by the joint delivery is returned to the consignors, the joint delivery price is set. For example, a trader X operates a joint delivery, and collects consignors publicly through the Internet. The delivery price of the trader X is, for example, 3,000 yen/t.

As an example, a case is considered in which the consignor A requests the trader X to deliver 9-ton cargo using a 10-ton truck with a charter fee of 20,000 yen. In this case, the delivery price for the consignor A is 27,000 yen, and the profit of the trader X is 7,000 yen. Here, a case is further considered in which the consignor B requests the trader X to deliver 1-ton cargo. In this case, the delivery price for both consignors is 30,000 yen, and the profit of the trader X is 10,000 yen. Compared to the former case, the profit of the trader X is increased by 3,000 yen.

The above increased profit is returned to each of the consignors according to the cargo ratio. For the simple description, the returning of the profit to the trader X is not considered here. In this case, 2,700 yen (=3,000 yen×9t/(9t+1t)) is returned to the consignor A, and 300 yen (=3,000 yen−2,700 yen) is returned to the consignor B.

In the technique disclosed in PTL 2, as described above, profits are returned to the consignor who increases the loading efficiency of the joint delivery and raises the profits to collect the consignors and to realize the joint delivery with higher profit. However, the technique of PTL 2 realizes the return of profits only when a new consignor is found by information disclosure to the Internet regarding delivery using a specific defined route. In the technique of PTL 2, the delivery price of each consignor is calculated based only on the cargo quantity (weight and volume). Therefore, it is not possible to return the operation cost improved by the change of conditions such as a delivery order, an arrival time, and the rating of truck, and to allocate the profit amount based on a plurality of factors other than the cargo quantity. Therefore, it is a challenge in the joint delivery to incorporate a mechanism that returns the effect of improvement due to the joint delivery in consideration of a plurality of factors other than the cargo quantity.

Therefore, an embodiment of the invention is made in view of at least one of the above problems, and supports a creation of joint delivery planning in consideration of allocation of delivery cost with more fairness.

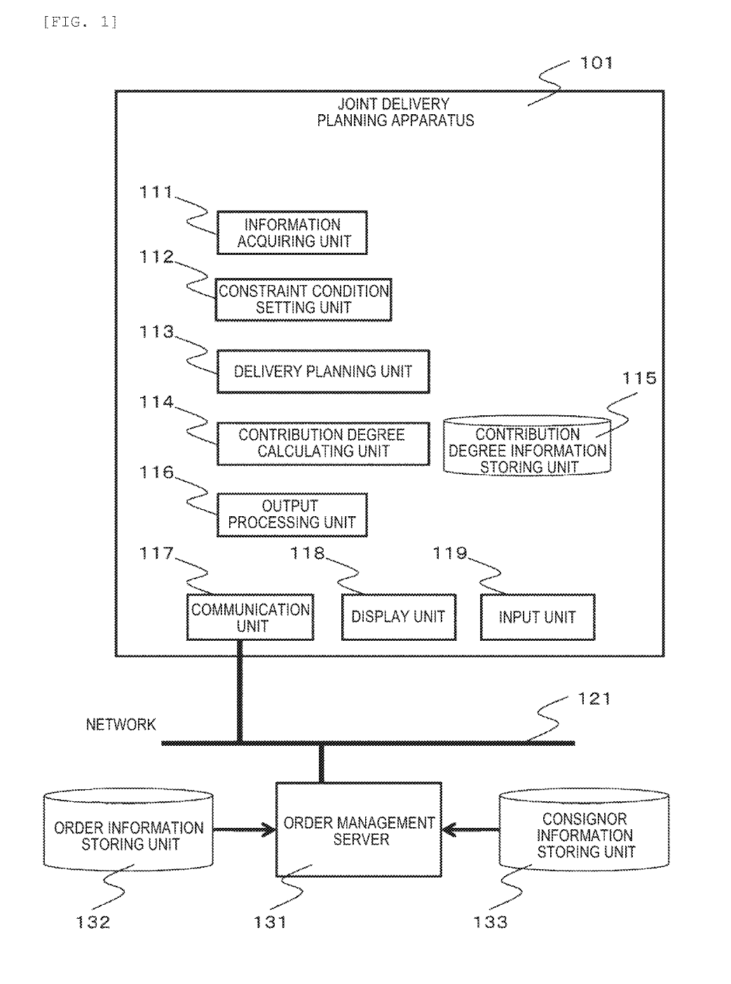

FIG. 1 is a diagram illustrating a configuration example of a joint delivery planning apparatus according to the embodiment of the invention.

A joint delivery planning apparatus 101 is connected to an order management server 131 via a network 121 such as the Internet. The order management server 131 is connected to an order information storing unit 132 and a consignor information storing unit 133. The order management server 131 reads order information of a plurality of consignors, who perform a joint delivery, from the order information storing unit 132, and transmits the read order information to the joint delivery planning apparatus 101 via the network 121. Further, the order management server 131 reads consignor information of the plurality of consignors, who perform the joint delivery, from the consignor information storing unit 133, and transmits the read consignor information to the joint delivery planning apparatus 101 via the network 121. The joint delivery planning apparatus 101 receives the order information and the consignor information of each consignor, and generates a joint delivery plan for jointly delivering cargoes of the respective consignors to the respective consignors using such information.

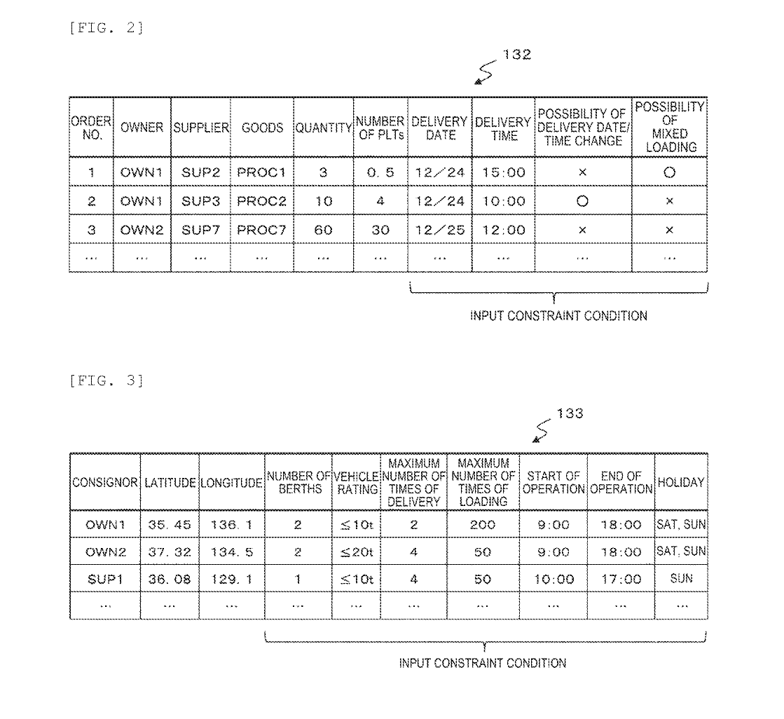

FIG. 2 is a diagram illustrating an example of a data structure of the order information storing unit 132. The order information storing unit 132 stores order information on goods to be delivered (cargo) that is, ordered goods. The order information includes items, for example, “order No. ”, “owner”, “supplier”, “goods”, “quantity”, “number of PLTs”, “delivery date”, “delivery time”, “possibility of delivery date/time change”, and “possibility of mixed loading. The “order No. ” is an identifier of an order. The “owner” is an identifier of an owner (consignor) of the relevant order, and the “supplier” is an identifier of a supplier of the relevant order. The “goods” is an identifier of the ordered goods. The “quantity” is an order quantity of the goods. The “number of PLTs” is a value obtained by converting the order quantity into a pallet unit which is a common unit of a cargo delivery. The “delivery date” indicates the date on which the goods should be delivered (arrived) to the owner. The “delivery time” indicates a time at which the goods should be delivered (arrived) to the owner. The “possibility of delivery date/time change” indicates whether the change of the delivery date and the delivery time is permitted. The “possibility of mixed loading” indicates whether the ordered goods may be delivered by stacking together with other goods in a cargo box of a transport vehicle such as the same truck.

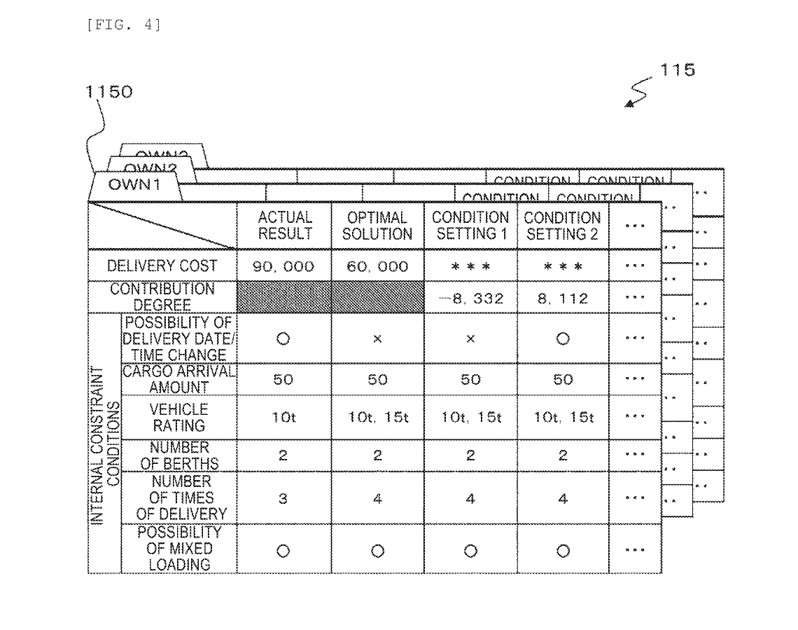

FIG. 3 is a diagram illustrating an example of a data structure of the consignor information storing unit. The consignor information storing unit 133 stores consignor information on each consignor who is an owner. The consignor information includes items, for example, “consignor”, “latitude”, “longitude”, “number of berths”, “vehicle rating”, “maximum number of times of delivery”, “maximum number of times of loading”, “start of operation”, “end of operation”, and “holiday”. The “consignor” is an identifier of a consignor (base). The “latitude” and “longitude” are position information of the consignor. The “number of berths” indicates the number of berths that are carrying sites of the transport vehicle such as a truck. The “vehicle rating” is rating of the transport vehicle such as the truck. The “maximum number of times of delivery” indicates the number of times of acceptance of the transport vehicle such as the truck for one day. The “maximum number of times of loading” is capacity in a pallet unit of a loading area in which the delivered goods are temporarily supplemented. The “start of operation” and the “end of operation” indicate business hours of the consignor. The “holiday” indicates the day off holiday of the consignor.

The order information and the consignor information are prerequisites to be considered in generating the joint delivery plan. However, the “delivery date”, the “delivery time”, the “possibility of delivery date/time change”, and the “possibility of mixed loading” included in the order information and the “number of berths”, the “vehicle rating”, the “maximum number of times of delivery”, the “maximum number of times of loading”, the “start of operation”, the “end of operation”, and the “holiday” included in the consignor information are treated as constraint conditions which are changeable. Hereinafter, these constraint conditions are collectively referred to as “input constraint conditions”, and each of the constraint conditions is called a constraint condition item. Naturally, the constraint condition item may include other items without being limited to the illustrated example.

Returning to the description of FIG. 1, the joint delivery planning apparatus 101 includes an information acquiring unit 111, a constraint condition setting unit 112, a delivery planning unit 113, a contribution degree calculating unit 114, a contribution degree information storing unit 115, an output processing unit 116, a communication unit 117, a display unit 118, and an input unit 119.

The communication unit 117 is connected to the network 121, and exchanges information with the order management server 131 or other computers via the network 121. The display unit 118 displays information to a user of the joint delivery planning apparatus 101 (for example, a forwarding agent who is responsible for the joint delivery). The input unit 119 accepts an input of information from the user of the joint delivery planning apparatus 101.

The information acquiring unit 111 acquires the order information and the consignor information used for generation of the joint delivery plan by the delivery planning unit 113 from the order management server 131 via the communication unit 117.

The constraint condition setting unit 112 extracts items that can be used in the joint delivery planning process from the items of the input constraint conditions included in the order information and the consignor information acquired by the information acquiring unit 111. In the embodiment, the “possibility of delivery date/time change”, the “cargo arrival quantity”, the “vehicle rating”, the “number of berths”, the “number of times of delivery, and the “possibility of mixed loading” are defined as changeable constraint conditions. These constraint conditions are collectively referred to as “internal constraint conditions”, and each of the constraint conditions is called a constraint condition item.

In addition, the constraint condition setting unit 112 changes and sets the internal constraint conditions of each consignor used for the generation of the joint delivery plan by the delivery planning unit 113 to constraint conditions of various multiple patterns.

The delivery planning unit 113 generates a joint delivery plan for jointly delivering cargoes of a plurality of consignors to the respective consignors. At this time, the delivery planning unit 113 acquires, as input information, the order information and the consignor information (excluding the input constraint condition) acquired by the information acquiring unit 111 and the internal constraint conditions set by the constraint condition setting unit 112, and obtains an optimal joint delivery plan (optimal solution) out of the joint delivery plans, which can be planned, based on the input information. A general technique such as a mathematical optimization method can be used as a method of generating an optimal joint delivery plan based on the order information and the consignor information, so a detailed description will not be presented. The generated joint delivery plan includes various types of information such as a total delivery cost of the plan, a delivery cost of each consignor, internal constraint condition of each consignor, a delivery route, and a delivery schedule.

The contribution degree calculating unit 114 calculates the contribution degree and the delivery cost (individual delivery cost on which the contribution degree is reflected) of each consignor relative to the total delivery cost indicated by each plan of the joint delivery plans generated by the delivery planning unit 113 based on the various internal constraint conditions. That is, it can be said that the contribution degree calculating unit 114 specifies the influence of the internal constraint conditions on the total delivery cost. The contribution degree calculating unit 114 stores, in the contribution degree information storing unit 115, contribution degree information on the contribution degree and the delivery cost of each consignor under the various internal constraint conditions.

The output processing unit 116 refers to the contribution degree information stored in the contribution degree information storing unit 115, generates screen information for displaying the contribution degree and the delivery cost for each internal constraint condition for each consignor, and outputs the screen information to the display unit 118. Upon receiving an operation to select a consignor and an internal constraint condition on the screen displayed on the display unit 118, from the user via the input unit 119, the output processing unit 116 generates screen information for displaying the contribution degree and the delivery cost corresponding to the selected consignor and internal constraint condition.

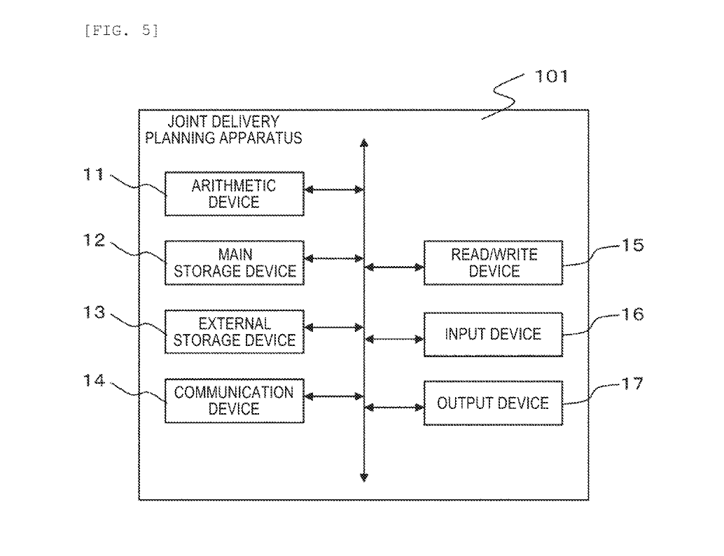

FIG. 4 is a diagram illustrating an example of a data structure of the contribution degree information storing unit. The contribution degree information storing unit 115 stores a table 1150 for each consignor. For each joint delivery plan (indicated by the identifiers (“actual result”, “optimal solution”, “condition setting 1”, “condition setting 2”, . . . ) on a horizontal axis) generated under different internal constraint conditions, “delivery cost”, “contribution degree”, and “internal constraint condition” are stored in the table 1150. The “delivery cost” indicates the delivery cost of the consignor in the joint delivery plan. The “contribution degree” indicates the contribution degree of the consignor in the joint delivery plan. The “internal constraint condition” indicates the internal constraint condition of the consignor in the joint delivery plan.

The “internal constraint condition” in the table 1150 is a changeable constraint condition, and includes items, for example, “possibility of delivery date/time change”, “cargo arrival quantity”, “vehicle rating”, “number of berths”, “number of times of delivery”, and “possibility of mixed loading” in the example of the drawing. The “possibility of delivery date/time change” indicates whether to prohibit or permit the change of the delivery date and the delivery time. The “cargo arrival quantity” indicates the cargo quantity in a pallet unit that can be arrived at the consignor for one day. The “vehicle rating” indicates vehicle ratings of truck (for example, only 10 tons, only 15 tons, 10 tons, or 15 tons) designated by the consignor. The “number of berths” indicates the number of trucks that can be simultaneously arrived at the consignor. The “number of times of deliver=y” indicates the number of times of delivery that the consignor can accept for one day. The “possibility of mixed loading” indicates whether the consignor prohibits or permits mixed loading with other cargoes.

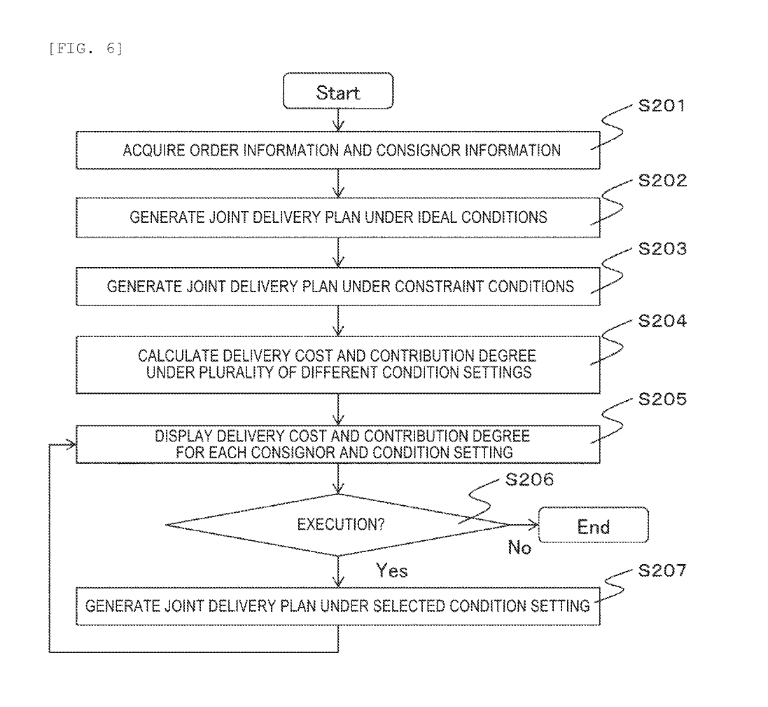

FIG. 5 is a diagram illustrating a configuration example of hardware of the joint delivery planning apparatus. The joint delivery planning apparatus 101 can be implemented by computer equipment, for example, a server computer, a personal computer, a smartphone, and a tablet computer. Naturally, the joint delivery planning apparatus 101 may be configured with a plurality of computers.

The joint delivery planning apparatus 101 includes an arithmetic device 11, a main storage device 12, an external storage device 13, a communication device 14, a read/write device 15, an input device 16, and an output device 17.

The arithmetic device 11 is, for example, an arithmetic unit such as a CPU (Central Processing Unit). The main storage device 12 is, for example, a storage device such as a RAM (Random Access Memory). The external storage device 13 is, for example, a storage device such as a hard disk, an SSD (Solid State Drive), or a flash ROM (Read Only Memory). The communication device 14 is a device that transmits and receives information and includes a communication device for performing wired communication via a network cable and a communication device for performing wireless communication via an antenna. The read/write device 15 is a device that reads and writes information from/on a recording medium such as a DVD (Digital Versatile Disk) or a USB (Universal Serial Bus) memory. The input device 16 is a device that accepts input information and includes a pointing device such as a keyboard and a mouse, a touch panel, and a microphone. The output device 17 is a device that outputs output information and includes a display, a printer, and a speaker. At least a part of the main storage device 12 and the external storage device 13 may be implemented by storage on the network connected via the communication device 14, for example.

The information acquiring unit 111, the constraint condition setting unit 112, the delivery planning unit 113, the contribution degree calculating unit 114, and the output processing unit 116 (which may be referred to as “arithmetic unit”) can be implemented when the arithmetic device 11 executes a predetermined application program, for example. The application program is stored, for example, in the eternal storage device 13, loaded on the main storage device 12 in executing, and executed by the arithmetic device 11. The contribution degree information storing unit 115 can be implemented by at least one of the main storage device 12 and the external storage device 13, for example. The communication unit 117 can be implemented by the communication device 14, for example. The display unit 118 can be implemented by, for example, the output device 17. The input unit 119 can be implemented by the input device 16, for example.

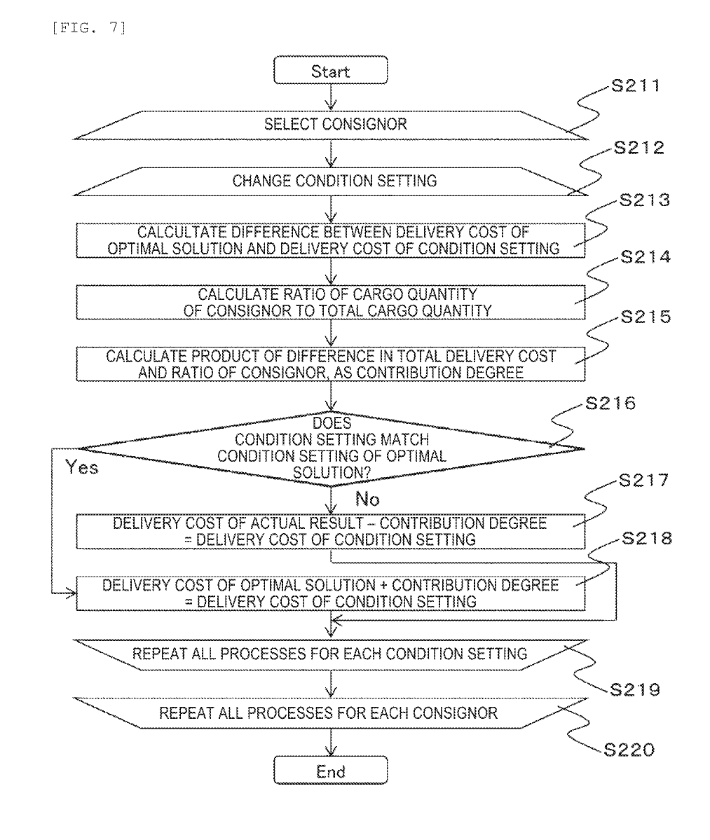

FIG. 6 is a flowchart illustrating a processing example of the joint delivery planning apparatus.

First, the information acquiring unit 111 acquires order information and consignor information from the order management server 131 via the communication unit 117 (step S201). The constraint condition setting unit 112 converts each item of input constraint conditions included in the acquired order information and consignor information into each item of internal constraint conditions usable in the joint delivery planning process.

Then, the delivery planning unit 113 generates a joint delivery plan under ideal conditions (step S202). Specifically, the delivery planning unit 113 generates a plan to jointly deliver cargoes of a plurality of consignors to each consignor using the order information and the consignor information (excluding input constraint conditions) acquired in step S201, which is a joint delivery plan in which a total delivery cost is minimum. In step S202, the delivery planning unit 113 generates a joint delivery plan independently of the internal constraint condition of each consignor set in step S201, By this process, the joint delivery plan of the optimal solution is calculated, the total delivery cost in the optimal solution and the delivery cost of each consignor are calculated, and the internal constraint conditions of each consignor in the optimal solution are specified. The contribution degree calculating unit 114 stores the calculated delivery cost of each consignor and the specified internal constraint conditions of each consignor in the column of the “optimal solution (see FIG. 4) ” in the table 1150 of each consignor.

Then, the delivery planning unit 113 generates a joint delivery plan under actual constraint conditions (actual result conditions) (step S203). Specifically, the delivery planning unit 113 generates a plan to jointly deliver cargoes of a plurality of consignors to each consignor using the order information and the consignor information (excluding input constraint conditions) acquired in step S201, which is a joint delivery plan in which a total delivery cost is minimum. In step S203, the delivery planning unit 113 generates a joint delivery plan according to the internal constraint conditions of each consignor set in step S201. By this process, the joint delivery plan under the constraint conditions is calculated, and the total delivery cost and the delivery cost of each consignor under the constraint conditions are calculated. The contribution degree calculating unit 114 stores the calculated delivery cost of each consignor and the set internal constraint conditions of each consignor in the column of the “actual result (see FIG. 4)” in the table 1150 of each consignor.

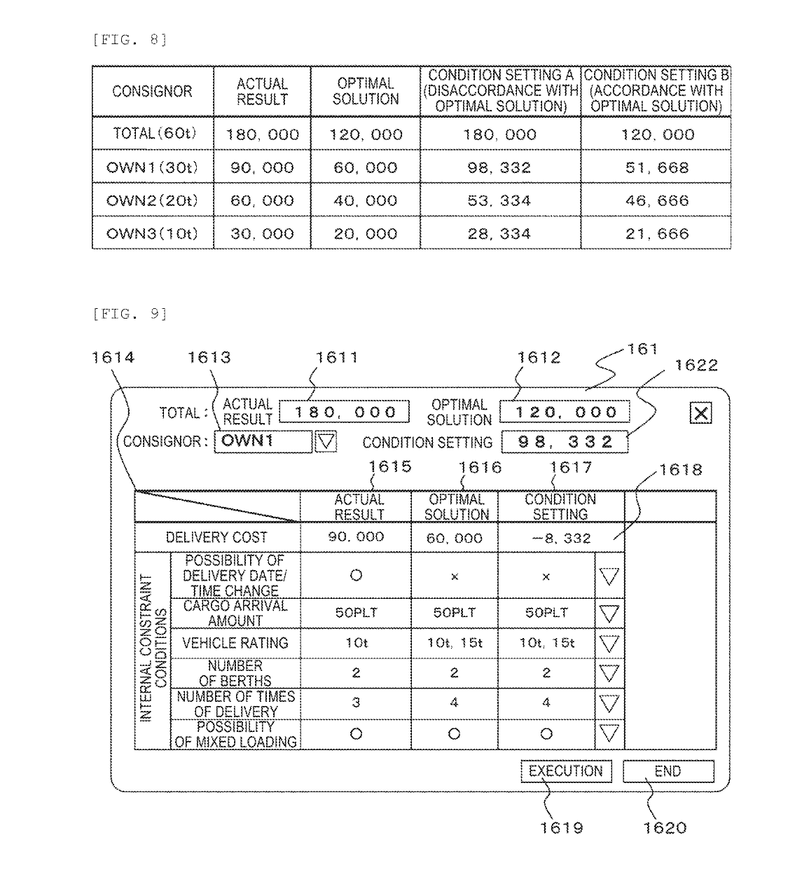

Then, the contribution degree calculating unit 114 calculates the delivery cost and the contribution degree of each consignor under a plurality of different condition settings (step S204). The details of step S204 will be described with reference to FIG. 7.

FIG. 7 is a flowchart illustrating an example of a process of calculating the contribution degree.

The constraint condition setting unit 112 selects each consignor incorporated in the joint delivery plan generated in step S202 or step S203, and repeats processes of step S212 to step S219 for each consignor (step S211 and step S220). Hereinafter, the selected consignor is called a “target consignor”.

In addition, the constraint condition setting unit 112 changes the condition setting of the internal constraint condition with respect to the target consignor, and repeats processes of step S213 to step S218 for each changed condition setting (step S212 and step S219). Specifically, in step S212, the constraint condition setting unit 112 changes values of the respective items constituting the internal constraint conditions illustrated in FIG. 4, and sequentially sets all the combination of values. The combination of the values of these internal constraint condition items is called “condition setting”.

The contribution degree calculating unit 114 calculates a difference between the delivery cost of the optimal solution and the delivery cost of the condition setting (step S213). Specifically, the contribution degree calculating unit 114 instructs the delivery planning unit 113 to generate a joint delivery plan in which a total delivery cost is minimum, using the order information and the consignor information (excluding input constraint conditions) acquired in step S201. Here, the delivery planning unit 113 uses the condition setting set in step S212 for the target consignor, and generates a joint delivery plan for each consignor other than the target consignor independently of the internal constraint condition. By this process, the total delivery cost in the set condition setting and the delivery cost of each consignor are calculated, and the condition setting of each another consignor is specified. The contribution degree calculating unit 114 stores the condition setting of the target consignor in the column of the “condition setting (see FIG. 4)” in the table 1150 of the target consignor. The “condition setting” column is added for each condition setting.

In addition, the contribution degree calculating unit 114 calculates the difference of the total delivery cost by subtracting the total delivery cost in the condition setting calculated in step S213 from the total delivery cost of the optimal solution calculated in step S202. Since the total delivery cost in the condition setting is a value larger than the total delivery cost of the optimal solution, the difference becomes a minus value.

Then, the contribution degree calculating unit 114 calculates a ratio of the cargo quantity of the consign or to the total cargo quantity (step S214). Specifically, the contribution degree calculating unit 114 refers to the order information acquired by the information acquiring unit 111, calculates the total cargo quantity by summing the number of PLTs of each consignor, and acquires the number of PLTs of the target consignor as the cargo quantity. Then, the contribution degree calculating unit 114 divides the cargo quantity of the target consignor by the total cargo quantity.

Then, the contribution degree calculating unit 114 calculates the product of the difference of the total delivery cost and the ratio of the consignor, as a contribution degree (step S215). Specifically, the contribution degree calculating unit 114 calculates the contribution degree (minus value) of the target consignor by multiplying the difference of the total delivery cost calculated in step S213 by the ratio of the target consignor calculated in step S214. The contribution degree calculating unit 114 stores the contribution degree of the target consignor in the column of the “condition setting (see FIG. 4)” in the table 1150 of the target consignor.

Then, the contribution degree calculating unit 114 determines whether the condition setting matches the condition setting of the optimal solution (step S216). Specifically, the contribution degree calculating unit 114 determines whether values of all the items of the condition setting of the target consignor set in step S212 match values of all the items of the condition setting of the target consignor in the optimal solution calculated in step S202.

When determining that the condition settings do not match each other (step S216: No), the contribution degree calculating unit 114 calculates the individual delivery cost of the target consignor in the condition setting set in step S212 by subtracting the contribution degree of the target consignor calculated in step S215 from the individual delivery cost of the target consignor in the actual result calculated in step S203 (step S217). The contribution degree calculating unit 114 stores the calculated individual delivery cost of the target consignor in the column of the “condition setting (see FIG. 4)” in the table 1150 of the target consignor.

When determining that the condition settings match each other (step S216: yes), the contribution degree calculating unit 114 calculates the individual delivery cost of the target consignor in the condition setting set in step S212 by adding the contribution degree of the target consignor calculated in step S215 to the individual delivery cost of the target consignor in the optimal solution calculated in step S202 (step S218). The contribution degree calculating unit 114 stores the calculated individual delivery cost of the target consignor in the column of the “condition setting (see FIG. 4)” in the table 1150 of the target consignor.

As described above, for each consignor, a contribution degree in a plurality of different condition settings and an individual delivery cost reflecting the contribution degree are calculated and set in the contribution degree information.

FIG. 8 is a diagram illustrating calculation of the delivery cost is consideration of the contribution degree. In the example of FIG. 8, it is assumed that a consignor OWN1, a consignor OWN2, and a consignor OWN3 participate in the joint delivery and the cargo quantities handled by the consignors are 30 tons, 20 tons, and 10 tons. Further, it is assumed that the constraint condition on the rating of truck used for delivery of each consignor is set to either only 5 tons or mixing of 10 tons and 5 tons.

Similarly to the optimal solution, when the consignor OWN1 permits the mixing of 10 tons and 5 tons (condition setting B), the total delivery cost is calculated to be 120,000 yen. Here, differently from the optimal solution (similarly to the actual result), when the consignor OWN1 permits only 5 tons due to circumstances (condition setting A), the total delivery cost is calculated to be 180,000 yen. This can be regarded as damaging as much as 60,000 yen to the total delivery cost by changing the constraint condition of the rating of truck. In this case, it can be interpreted that the delivery costs of the consignor OWN2 and the consignor OWN3 suffer the damages of 20,000 yen and 10,000 yen, respectively, from the consignor OWN1 depending on the ratio of handling cargo quantity.

In order to compensate the amount of damage to another consignor from the consignor OWN1, therefore, the amount of damage (original profit amount) of another consignor is normalized with the ratio of the cargo quantity of the consignor to the total cargo quantity, and is allocated to the consignor. Since the consignor OWN2 can originally earn 20,000 yen, 6,666 yen (=20,000 yen×(20t/60t)) is compensated from the consignor OWN1 (added to the consignor OWN1). Since the Consignor OWN3 can originally earn 10,000 yen, 1,666 yen (=10,000 yen×(10t/60t)) is compensated from the consignor OWN1 (added to the consignor OWN1). As a result, the delivery costs of the consignor OWN1, the consignor OWN2, and the consignor OWN3 are 98,332 yen, 53,334 yen, and 28,334 yen, respectively.

On the other hand, as in the case of the optimal solution, when the consignor OWN1 permits the mixing of 10t/5t (condition setting B), it can be interpreted that the consignor OWN1 contributes to the optimal joint delivery plan and can receive a reward from another consignor. Since the consignor OWN2 can earn 20,000 yen, the consignor OWN2 endows 6,666 yen (=20,000 yen×(20t/60t)) to the consignor OWN1 (subtracted from the consignor OWN1). Since the consignor OWN3 can earn 10,000 yen, the consignor OWN3 endows 1,666 yen (=10,000 yen×(10t/60t)) to the consignor OWN1 (subtracted from the consignor OWN1). As a result, the delivery costs of the consignor OWN1, the consignor OWN2, and the consignor OWN3 are 51,668 yen, 46,666 yen, and 21,666 yen, respectively.

The calculation of the contribution degree of each consignor and the delivery cost in consideration of the contribution degree in the flowchart of FIG. 7 is to obtain information as a hint for realizing the concept of FIG. 8 described above. By referring to the contribution degree and the delivery cost in various condition settings of each consignor, the user can determine the condition setting and the influence amount of each consignor that affect the total delivery cost of the joint delivery plan.

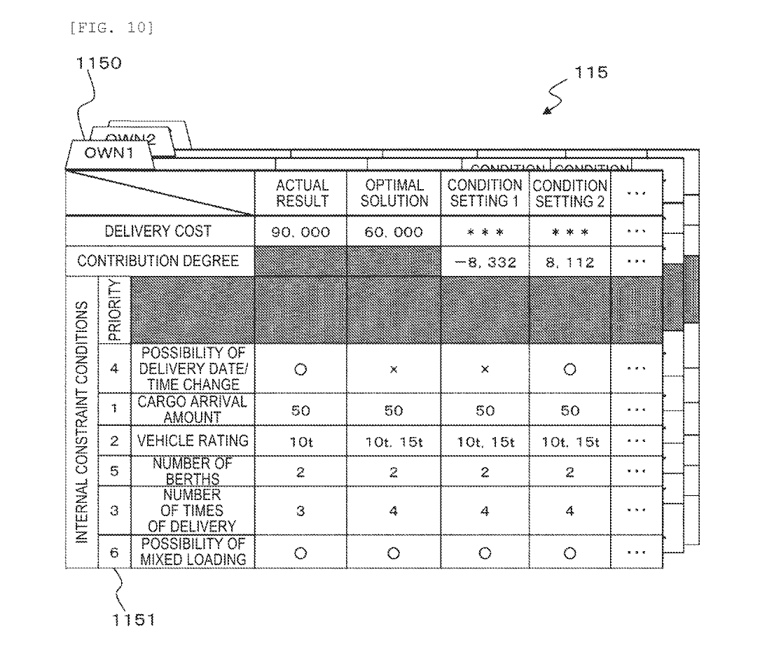

Returning to FIG. 6, after step S204, the output processing unit 116 displays the delivery cost and the contribution degree for each consignor and condition setting (step S205). Specifically, the output processing unit 116 refers to the contribution degree information storing unit 115, and generates a screen 161 as illustrated in FIG. 9 to display the screen on the display unit 118. Further, the output processing unit 116 accepts an operation on the screen 161 from the user via the input unit 119, and generates the screen 161 according to the operation.

FIG. 9 is a diagram illustrating an example of an output screen of the joint delivery planning apparatus. The screen 161 includes an area 1611 on which the total delivery cost of the actual result is displayed, an area 1612 on which the total delivery cost of the optimal solution is displayed, an area 1613 on which the consignor is selected, an area 1622 on which the delivery cost of the consignor in the condition setting indicated on an area 1617 is displayed, an area 1614 (including areas 1615 to 1618) on which the delivery cost and the contribution degree of the selected consignor are displayed, an execution button 1619, and an end button 1620.

The output processing unit 116 displays the total delivery cost of the actual result calculated in step S203 on the area 1611. The output processing unit 116 displays the total delivery cost of the optimal solution calculated in step S202 on the area 1612.

In addition, the output processing unit 116 refers to the table 1150 (see FIG. 4) associated with the consignor selected on the area 1613, and displays the information set in the table 1150 on the area 1614. Specifically, the output processing unit 116 displays the delivery cost and the values of items of the internal constraint condition which are set in the “actual result” of the table 1150, on the area 1615. Further, the output processing unit 116 displays the delivery cost and the values of items of the internal constraint condition which are set in the “optimal solution” of the table 1150, on the area 1616.

In addition, the output processing unit 116 displays the delivery cost and the contribution degree set in any one of the plurality of “condition settings” in the table 1150 of the selected consignor, on the area 1622 and the area 1617. Specifically, the area 1617 can accept the item values of the internal constraint condition in a selectable (changeable) manner by a pull-down menu or a direct input, for example. The output processing unit 116 specifies the “condition setting” having the internal constraint condition matching the internal constraint condition accepted in the area 1617 from the table 1150, and displays the delivery cost set in the specified “condition setting” on the area 1622. Further, the output processing unit 116 displays the contribution degree set in the specified “condition setting” on the area 1618 in the area 1617 (indicated by “−8,332” in the drawing).

Using the screen 161 described above, the user can examine the delivery cost and the contribution degree while changing the internal constraint condition of each consignor, and can determine the internal constraint condition of each consignor based on the examination result.

Returning to FIG. 6, the constraint condition setting unit 112 determines whether the execution button 1619 or the end button 1620 is operated (step S206). When the end button 1620 is operated (step S206: No), the delivery planning unit 113 outputs the joint delivery plan under the constraint conditions generated in step S203, and ends the process of this flowchart. The joint delivery plan is output to the display unit 118, the user's terminal, and the terminal of each consignor, for example.

When the execution button 1619 is operated (step S206: Yes), the delivery planning unit 113 generates the joint delivery plan under the selected condition setting (S207), and returns the process to step S205. Specifically, the delivery planning unit 113 generates a plan to jointly deliver cargoes of the plurality of consignors to each consignor using the order information and the consignor information (excluding the input constraint condition) acquired in step S201, which is a joint delivery plan in which the total delivery cost becomes minimum. In step S207, the delivery planning unit 113 acquires the internal constraint conditions of all consignors set on the screen 161, and generates a joint delivery plan according to the internal constraint conditions of each consignor. Through this process, the joint delivery plan under the constraint conditions set as a user's examination result is calculated, and the total delivery cost and the delivery cost of each consignor under the constraint conditions are calculated. Further, the delivery planning unit 113 outputs the generated joint delivery plan. The joint delivery plan is output to the display unit 118, the user's terminal, and the terminal of each consignor, for example.

The embodiment of the invention is described above. According to the embodiment, it is possible to support the creation of the joint delivery plan in consideration of allocation of the delivery cost with more fairness. That is, using the joint delivery planning apparatus 101 of the embodiment, the user can refer to the contribution degree and the delivery cost in various condition settings of each consignor and can examine the condition setting and the influence amount of each consignor who affects the total delivery cost of the joint delivery plan. In addition, the user can determine the internal constraint conditions of each consignor based on the examination result, and can create the joint delivery plan in consideration of the allocation of the delivery cost with fairness.

### First Modification

In a first modification of the above embodiment, priority is set for each item of the internal constraint condition. Hereinafter, differences from the above embodiment will be mainly described.

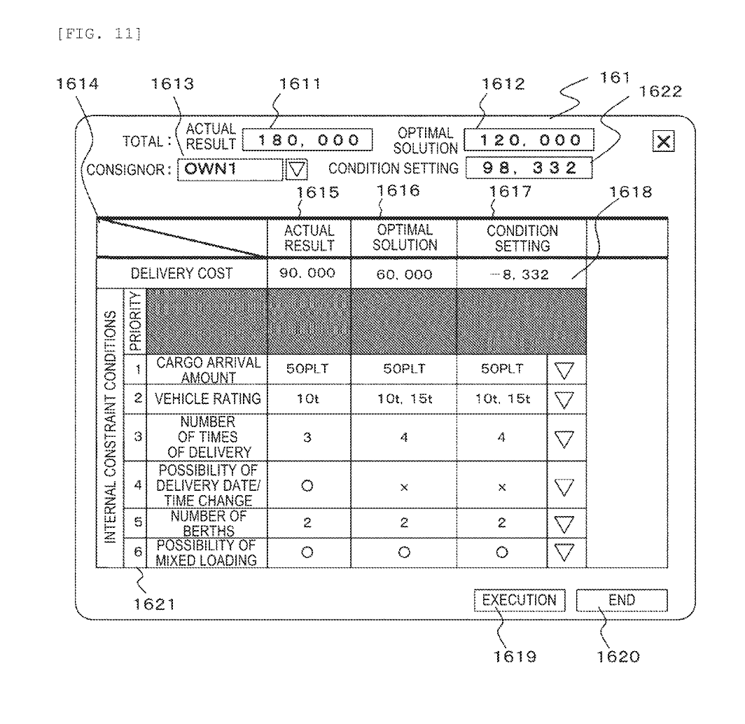

FIG. 10 is a diagram illustrating an example of a data structure of a contribution degree information storing unit according to the first modification. A table 1150 includes a field 1151 for setting the priority of each item of the internal constraint condition. A constraint condition setting unit 112 or an output processing unit 116 accepts the priority of each item of the internal constraint condition from the user via an input unit 119, for example, and sets the priority in the field 1151. The constraint condition setting unit 112 or the output processing unit 116 may accept the setting of the common priority for all consignors and set it in the field 1151 of all consignors, or may accept individually the setting of the priority for each consignor and set it in the field 1151 of each consignor.

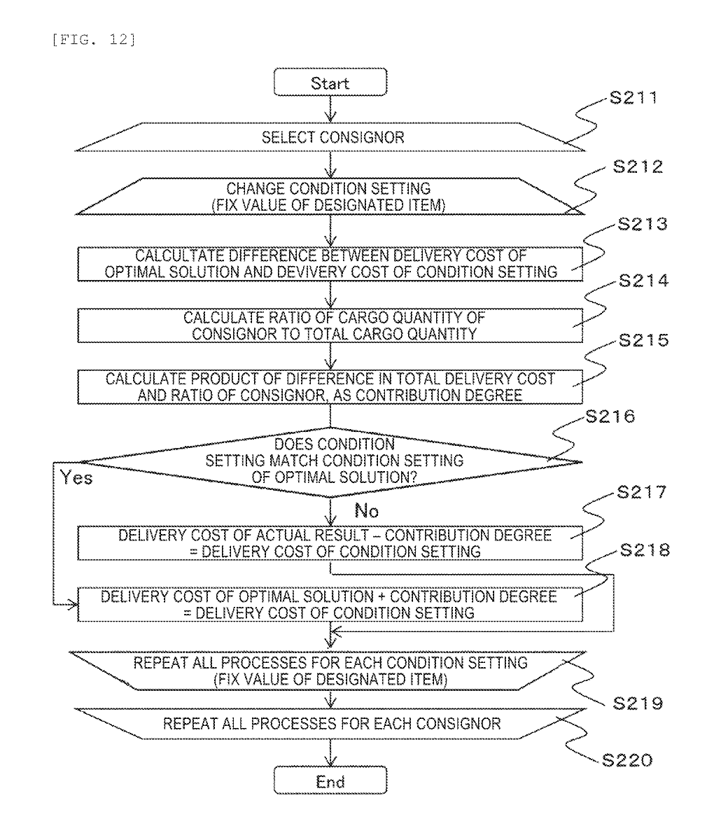

FIG. 11 is a diagram illustrating an example of a screen according to the first modification. A screen 161 includes an area 1621 on which the priority of each item of the internal constraint condition is displayed. The output processing unit 116 displays the items in parallel in order of priority according to the priority of each item set in the field 1151 of the table 1150. In addition, the output processing unit 116 displays values of the items in parallel in order of priority according to the priority, on an area 1615, and area 1616, and an area 1617. The output processing unit 116 may accept the change of the priority of each item in the area 1621, and change the display order of each item.

According to the first modification, it is possible to control so that the constraint condition having high priority is displayed on the higher level according to circumstances of each consignor. This makes it possible to efficiently set the constraint condition of each consignor and to prevent the constraint condition having the high priority from being erroneously changed.

### Second Modification

In a second modification of the above embodiment, a joint delivery planning apparatus 101 has a configuration for reducing the amount of calculation. Hereinafter, differences from the first modification will be mainly described.

In the flowchart illustrated in FIG. 7, the constraint condition setting unit 112 sets combinations of all the values of each item of the internal constraint condition. In this case, the amount of calculation and calculation time by the delivery planning unit 113 become enormous, and there is a fear that troubles may arise in the work of the user. Therefore, the value of the item of the predetermined constraint condition is fixed in the second modification. For example, since the rating of a truck usually depends on the size of the truck carrying site of the consignor, there is no point in changing the value unless the site is remodeled. In such a case, the rating of the truck may be fixed.

Specifically, the constraint condition setting unit 112 or the output processing unit 116 accepts a setting, in which the value of any one or more designated items is fixed, from the user via the input unit 119 in addition to the priority of each item of the internal constraint condition, and sets it in a field 1151. The priority of the designated item is set to the lowest. The constraint condition setting unit 112 or the output processing unit 116 may accept a setting common to all consignors and set it in the field 1151 of all consignors, or may individually accept settings for each consignor and set it in the field 1151 of each consignor.

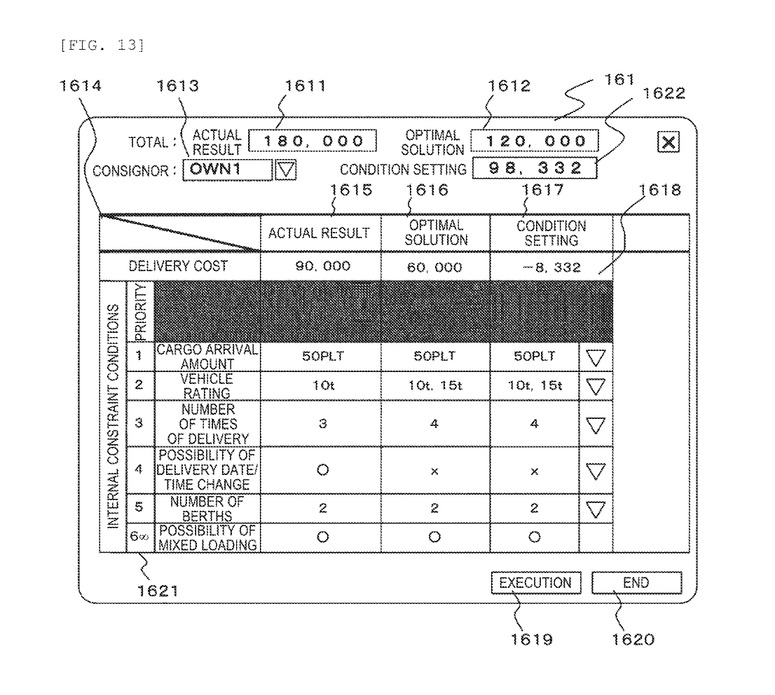

FIG. 12 is a flowchart illustrating an example of a process of calculating a contribution degree according to the second modification. Compared with the flowchart of FIG. 7, processes of steps S212 and S219 are different. That is, the constraint condition setting unit 112 fixes the values of one or more designated items of the internal constraint condition according to the setting in the field 1151, changes the values of other items, and sequentially sets the combinations of all the values.

FIG. 13 is a diagram illustrating an example of a screen according to the second modification. The output processing unit 116 displays a mark (“∞” in the drawing) indicating fixation of the item whose value is fixed in the area 1621 according to the setting of each item set in the field 1151 of the table 1150. The item whose value is fixed is displayed at the lowest position. In addition, the output processing unit 116 sets the value of the item whose value is fixed among the items included in the area 1617 to be unselectable (unchangeable) (in the drawing, a pull-down menu is not displayed).

According to the second modification, the value of the designated constraint condition item is fixed. Thus, it is possible to reduce the amount of calculation and calculation time. In addition, it is possible to prevent the value of the designated constraint condition item from being erroneously changed on the screen. The example of setting the priority and accepting the setting for fixing the value is described in the second modification, but only the setting for fixing the value may be accepted,

### Third Modification

In the above embodiment, the joint delivery plan scheduled to be operated is output. However, after the joint delivery is started based on the joint delivery plan, if the arrival at the specific consignor is delayed to the afternoon due to, for example, traffic jam, the joint delivery may not proceed as planned. Under such circumstances, for example, the change in the arrival time of any consignor is permitted, and thus the joint delivery may be realized to satisfy the initial plan as much as possible. Therefore, the third modification has a configuration in which the joint delivery plan is changed according to the situation.

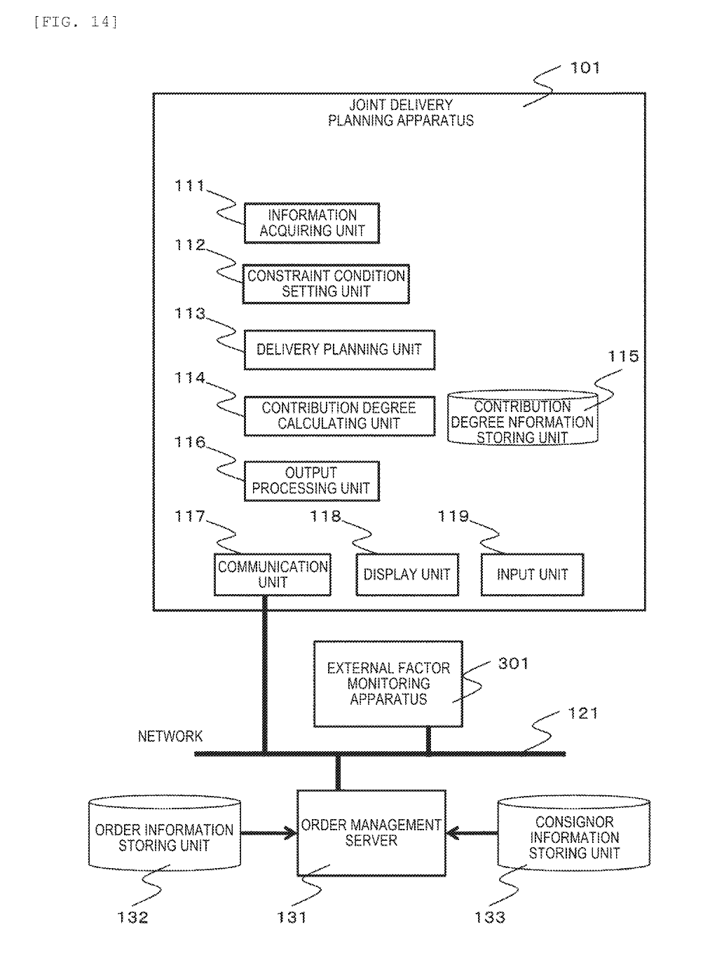

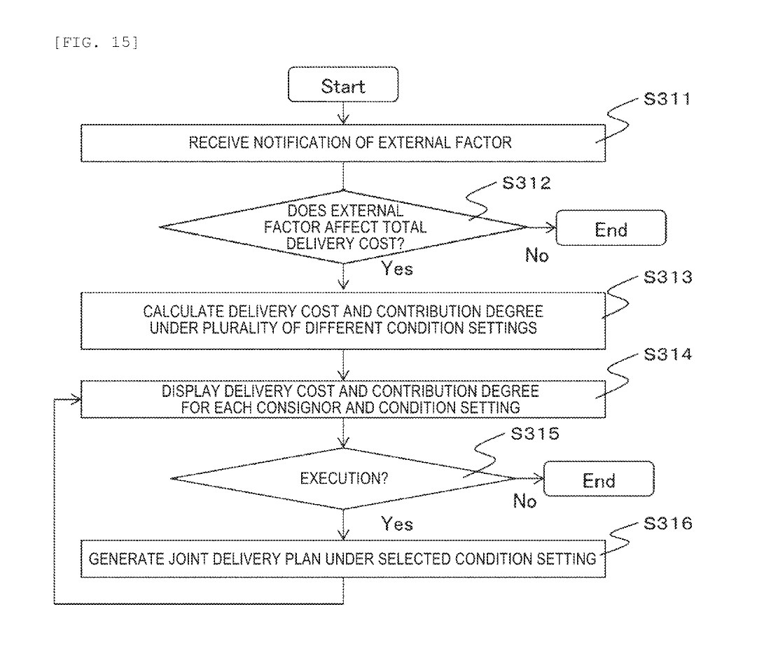

FIG. 14 is a diagram illustrating a configuration example of a joint delivery planning apparatus according to the third modification. A joint delivery planning apparatus 101 is connected to an external factor monitoring apparatus 301 via a network 121. The delivery planning unit 113 outputs the joint delivery plan generated in the process illustrated in FIG. 6 to the external factor monitoring apparatus 301 via a communication unit 117.

The external factor monitoring apparatus 301 monitors external factors affecting the total delivery cost after starting operation of the joint delivery plan output from the joint delivery planning apparatus 101. For example, the external factor monitoring apparatus 301 monitors whether traffic congestion has occurred in a route of the planned joint delivery. The traffic congestion affects the total delivery cost depending on the degree of congestion and an occurrence place. The external factor monitoring apparatus 301 notifies the joint delivery planning apparatus 101 when detecting the external factors.

FIG. 15 is a flowchart illustrating a processing example of the joint delivery planning apparatus according to the third modification.

First, an information acquiring unit 111 receives notification of the external factors via the communication unit 117 (step S311). Then, a contribution degree calculating unit 114 determines whether the received external factors affect the total delivery cost (step S312). The contribution degree calculating unit 114 determines that the total delivery cost is affected when the degree of the traffic congestion is equal to or greater than a predetermined value. When determining that the total delivery cost is not affected (step S312: No), the contribution degree calculating unit 114 ends the process of this flowchart.

When determining that the total delivery cost is affected (step S312: Yes), the contribution degree calculating unit 114 calculates the delivery cost and the contribution degree with a plurality of different condition settings (step S313). Step S313 is the same as step S204 in FIG. 6. The joint delivery plan of the optimal solution and the joint delivery plan of the actual result generated in steps S202 and S203 of FIG. 6 can be used.

Then, the processes of steps S314 to 5316 are executed. The processes of steps S314 to S316 are the same as the processes of steps S205 to S207 in FIG. 6. The delivery planning unit 113 also outputs the generated joint delivery plan to the external factor monitoring apparatus 301 via the communication unit 117.

According to the third modification, when the external factors occur after the joint delivery is started, the user can determine the internal constraint condition of each consignor again and create the joint delivery plan in consideration of allocation of the delivery cost with fairness. For example, the user can change the values of the constraint condition items such as possibility of delivery date/time change of each consignor, the number of berths, and the number of times of delivery when the traffic congestion occurs.

The configuration of the joint delivery planning apparatus 101 illustrated in FIGS. 1, 5, and 14 is classified depending on main processing contents for the sake of easy understanding of the configuration of the joint delivery planning apparatus 101. The classification method and the name of the components do not restrict the present invention. The configuration of the joint delivery planning apparatus 101 may be further classified into a larger number of components depending on processing contents. Moreover, the configuration may be classified so that a single component can carry out more pieces of the processing. Moreover, the processing by each of the components may be carried out by a single piece of hardware or a plurality of pieces of hardware. Moreover, the allocation of the processing or the function of each of the components is not limited to the one shown in the drawings as long as it can achieve the objects and advantages of the present invention.

Note that the processing units of the flowcharts illustrated in FIGS. 6, 7, 12, and 15 are classified depending on main processing contents for the sake of easy understanding of the processing of the joint delivery planning apparatus 101. The classification method and the names of the processing units do not restrict the present invention. The processing of the joint delivery planning apparatus 101 can be classified into further more processing units according to the processing contents, and can be classified so that one processing unit includes further more processing. If the objects and advantages of the present invention can be achieved, the above-described processing order of the flowchart is not limited to the example illustrated in the drawings.

In this respect, the present invention is not limited to the above-described embodiment but it includes various modified examples. For instance, the above-described embodiment has been described in details for clearly explaining the present invention while the present invention is not to be limited to a configuration including ail of the explained components. In addition, a part of the configuration of the embodiment can be replaced with the configuration of another embodiment, and the configuration of another embodiment can be added to the configuration of a certain embodiment. It is possible to add, omit or replace a part of the components of the embodiment with other components.

Further, a part or all of the above components, functions, processing units and processing means might be realized through hardware by designing them, for instance, on an integrated circuit. Moreover, the above components or functions might also be realized through software by interpreting and executing programs realizing respective functions by means of a processor. Information such as programs, tables or files realizing the functions can be stored in a memory, a storage device such as a hard disk or an SSD, or a recording medium such as an IC card, an SD card, or a DVD. Further, there are shown only control lines and information lines which are deemed to be necessary for explanations, and it is not necessarily the case that all control lines and information lines of products are shown. In reality, it might be considered that almost all components are mutually connected.

The invention can be provided not only in the joint delivery planning apparatus and the joint delivery planning method but also in various aspects such as a computer readable program executed in the joint delivery planning apparatus and a joint delivery planning system.

1. A joint delivery planning apparatus that generates a joint delivery plan to jointly deliver cargoes of a plurality of consignors to each of the consignors, the apparatus comprising:
an information acquiring unit that acquires order information of each of the consignors and consignor information on each of the consignors;
a constraint condition setting unit that sets a plurality of constraint conditions for each of the consignors by changing constraint conditions of each of the consignors;
a delivery planning unit that generates the joint delivery plan for each of the constraint conditions of each of the consignors, using the order information, the consignor information, and the plurality of constraint conditions of each of the consignors;
a contribution degree calculating unit that calculates a contribution degree of the consignor with respect to a total delivery cost indicated by the corresponding joint delivery plan for each of the constraint conditions;
a contribution degree information storing unit that stores the contribution degree for each of the constraint conditions of each of the consignors; and
an output processing unit that outputs the contribution degree for each of the constraint conditions of each of the consignors with reference to the contribution degree information storing unit.

2. The joint delivery planning apparatus according to claim 1, wherein
the output processing unit accepts selection of the consignor and the constraint conditions of the consignor, acquires the contribution degree corresponding to the selected consignor and constraint conditions from the contribution degree information storing unit, and outputs the acquired contribution degree.

3. The joint delivery planning apparatus according to claim 1, wherein
the delivery planning unit generates a joint delivery plan under ideal conditions, using the order information and the consignor information of each of the consignors, and
the contribution degree calculating unit calculates the contribution degree of the consignor, based on a difference between a total delivery cost indicated by the joint delivery plan under the ideal conditions and a total delivery cost indicated by the joint delivery plan under the constraint conditions and a ratio of a cargo quantity of the consignor to a total cargo quantity.

4. The joint delivery planing apparatus according to claim 1, wherein
the contribution degree calculating unit calculates an individual delivery cost of the consignor reflecting the contribution degree for each of the constraint conditions,
the contribution degree information storing unit stores the individual delivery cost for each of the constraint conditions of each of the consignors, and
the output processing unit outputs the individual delivery cost for each of the constraint conditions of each of the consignors, together with the contribution degree.

5. The joint delivery planning apparatus according to claim 4, wherein
the delivery planning unit generates a joint delivery plan under ideal conditions using the order information and the consignor information of each of the consignors, and generates a joint delivery plan under actual result conditions using the order information, the consignor information, and the input constraint conditions of each of the consignors, and
the contribution degree calculating unit determines whether constraint conditions under the ideal conditions match the constraint conditions set by the constraint condition setting unit, reflects the contribution degree by adding the contribution degree to an individual delivery cost under the ideal conditions when both of the constraint conditions match, and reflects the contribution degree by subtracting the contribution degree from an individual delivery cost under the actual result conditions when both of the constraint conditions do not match.

6. The joint delivery planning apparatus according to claim 2, wherein
the constraint condition is constituted by a plurality of constraint condition items,
the constraint condition setting unit sets a priority for each of the constraint condition items, and
the output processing unit outputs the constraint condition of the consignor by arranging the constraint condition items according to the priority.

7. The joint delivery planning apparatus according to claim 1, wherein
the constraint condition is constituted by a plurality of constraint condition items, and
the constraint condition setting unit accepts a setting for fixing at least one of the constraint condition items and changes values of items other than the fixed constraint condition item of the constraint condition.

8. The joint delivery planning apparatus according to claim 7, wherein
the output processing unit accepts selection of the consignor and the constraint conditions of the consignor, acquires the contribution degree corresponding to the selected consignor and constraint conditions from the contribution degree information storing unit, and outputs the acquired contribution degree, and
the output processing unit accepts selection of values for items other than the fixed constraint condition item.

9. The joint delivery planning apparatus according to claim 1, wherein
the information acquiring unit receives a notification of an external factor affecting the total delivery cost of the joint delivery plan to be operated, from a monitoring apparatus,
the contribution degree calculating unit calculates the contribution degree of the consignor for each of the constraint conditions when the notification is received, and
the output processing unit outputs the contribution degree for each of the constraint conditions of each of the consignors.

10. A joint delivery planning method of generating a joint delivery plan to jointly deliver cargoes of a plurality of consignors to each of the consignors, the method comprising steps of:
preparing a joint delivery planning apparatus including an arithmetic unit and a storage unit;
acquiring order information of each of the consignors and consignor information on each of the consignors, by the arithmetic unit;
setting a plurality of constraint conditions for each of the consignors by changing constraint conditions of each of the consignors, by the arithmetic unit;
generating the joint delivery plan for each of the constraint conditions of each of the consignors, by the arithmetic unit, using the order information, the consignor information, and the plurality of constraint conditions of each of the consignors;
calculating a contribution degree of the consignor with respect to a total delivery cost indicated by the corresponding joint delivery plan for each of the constraint conditions, by the arithmetic unit;
storing the contribution degree for each of the constraint conditions of each of the consignors in the storage unit, by the arithmetic unit; and
outputting the contribution degree for each of the constraint conditions of each of the consignors with reference to the storage unit, by the arithmetic unit.
